(19) United States
(12) Patent Application Publication
(10) Pub. No.: US 2004/0016409 A1
(43) Pub. Date: Jan. 29, 2004

(54) Secure animal carrier

(76) Inventors: Kurt A. Schwinghammer, Yardley, PA (US); Rajiv Menon, Wallingford, PA (US); Flaura Winston, Narberth, PA (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/406,436

(22) Filed: Apr. 3, 2003

Related U.S. Application Data
(60) Provisional application No. 60/369,534, filed on Apr. 3, 2002.

(51) Int. Cl. A01K 31/07

(52) U.S. Cl. 119/453

(57) ABSTRACT

The present invention relates to an animal carrier which can be secured to a vehicle seat using a Low Anchors and Tethers for Children (LATCH) system. The animal carrier of the present invention includes a crate for securing the animal. A LATCH compatible attachment is coupled to the rear or side of the crate. The LATCH compatible attachment includes a hook which can be secured to a LATCH system anchored in a vehicle. After use, the LATCH compatible attachment can be retracted into the crate.

### BACKGROUND OF THE INVENTION

1. Field of the Invention

The present invention relates to an animal carrier that can be expeditiously secured to a vehicle.

2. Description of the Related Art

Animal carriers have been used to transport animals. The animal carriers have been placed in vehicles or airplane cabins. Oftentimes, animal carriers slide on vehicle seats when turning or braking and/or fall forward when braking which can cause a vehicle operator to lose concentration or attempt to secure the carrier while operating the vehicle.

U.S. Pat. No. 5,941,195 describes a portable animal carrier which can be secured to an airplane or automobile seat. A supplemental strap accommodates insertion into an automobile safety strap for retaining the portable animal carrier in the automobile during movement of the automobile.

U.S. Pat. No. 6,223,691 relates to an animal carrier for use inside and outside of vehicles. The carrier includes a cage-like enclosure and a carriage for supporting the enclosure. At least one wedge is secured with the cage-like enclosure or the carriage. When the carrier is positioned on the vehicle seat, the wedge is adapted to be engaged with a seat belt of the vehicle, thereby fixedly securing the carrier to the seat of the vehicle. The seat belt is drawn through holes in the wedge and is fastened in its usual position to the seat. This patent has the drawback of being cumbersome to attach the carrier to the seat belt.

It is desirable to provide a vehicle carrier which can be easily and expeditiously attached to the vehicle seat.

### SUMMARY OF THE INVENTION

The present invention relates to an animal carrier which can be secured to a vehicle seat using a Low Anchors and Tethers for Children (LATCH) system. A Low Anchors and Tethers for Children (LATCH) system is described in NHTSA Child Passenger Safety Tech Report, 1999, http://www.nhtsa.dot.gov/people/injury/childps/CPSTUR/TechW99.htm, hereby incorporated by reference into this application. The LATCH system is mandated by the National Highway Traffic Safety Administration (NHTSA) to be included in all vehicles manufactured after 2002.

The animal carrier of the present invention includes a crate for securing the animal. A LATCH compatible attachment is coupled to the rear or side of the crate. The LATCH compatible attachment includes a hook which can be secured to a LATCH system anchored in a vehicle. After use, the LATCH compatible attachment can be retracted into the crate. The invention will be more fully described in reference to the following drawings.

### BRIEF DESCRIPTION OF THE DRAWINGS

FIG. 1A is a front view of the secure animal carrier of the present invention.

FIG. 1B is a side view of the secure animal carrier of the present invention.

FIG. 1C is a rear view of the secure animal carrier of the present invention.

FIG. 1D is a side view of the secure animal carrier in which a Low Anchors and Tethers for Children (LATCH) compatible attachment extends from a side frame of the carrier.

FIG. 2A is a side view of a LATCH compatible attachment for use in the present invention.

FIG. 2B is a top plan view of the LATCH compatible attachment shown in FIG. 2A.

FIG. 3 is a perspective view of attachment of the secured vehicle carrier to a vehicle seat.

FIG. 4 is a side elevational view of a LATCH system.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

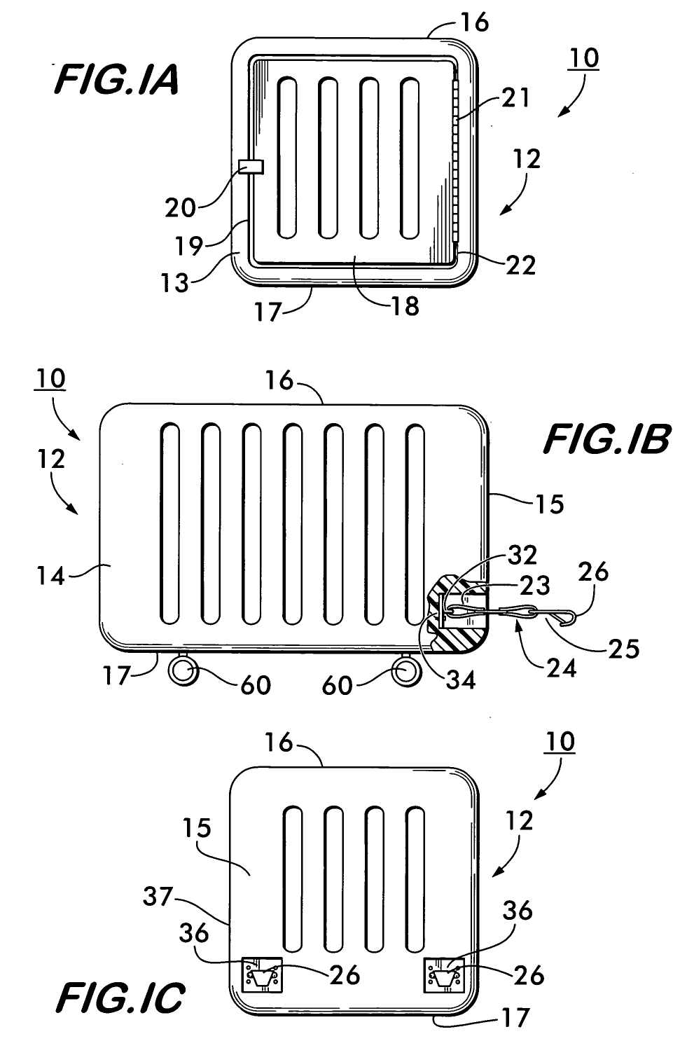

FIGS. 1A-1D illustrate secure animal carrier 10 in accordance with the teachings of the present invention. Animal crate 12 is formed of front frame 13, a pair of side frames 14 and rear frame 15 attached or integral to one another and top 16 and bottom 17. Door 18 is formed in front frame 13 of animal crate 12. Door 18 attaches to edge 19 of front frame 13 with attachment 20. Hinge 21 attaches to edge 22 of front frame 13 for providing opening and closing of door 18.

LATCH compatible attachment 24 is coupled to animal crate 12. In one embodiment, end 23 of LATCH compatible attachment 24 extends into side frame 14. Alternatively, end 23 of LATCH compatible attachment 24 extends into rear frame 15. End 25 of LATCH compatible attachment 24 extends from rear frame 15. In one embodiment, LATCH compatible attachment extends from side frame 14, as shown in FIG. 1D. Alternatively, LATCH compatible attachment can be coupled by conventional techniques to animal crate 12.

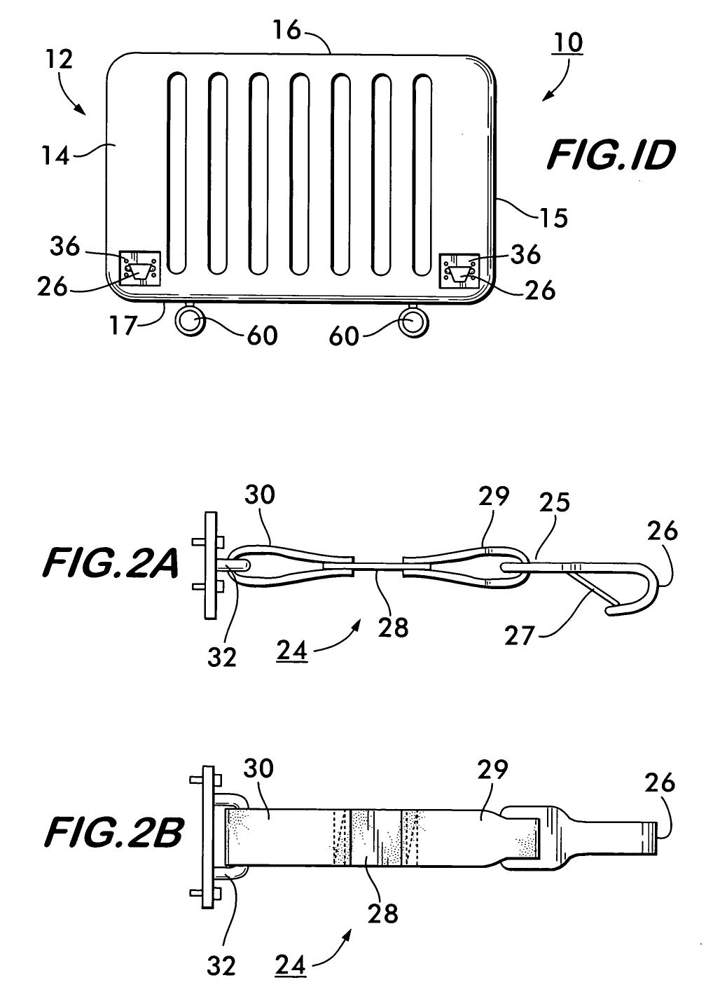

FIGS. 2A-2B are detailed views of LATCH compatible attachment 24. LATCH compatible attachment 24 has hook 26 at end 25. Retaining slide 27 can be attached to hook 26. End 29 of belt 28 is attached to hook 26. End 30 of belt 28 attaches to mount 32.

LATCH compatible attachment 24 is attached to side frame 14 using mount 32. Mount 32 is mounted to inside wall 34 of side frame 14, as shown in FIG. 1B. Alternatively, LATCH compatible attachment 24 can be attached to inside 37 of rear frame 15. Hook 26 extends through opening 36 in rear frame 15, as shown in FIG. 1C. Belt 28 can be formed of a flexible material to allow belt 28 to retract around mount 32 in a retracted position and to be extended from opening 36 in an extended position.

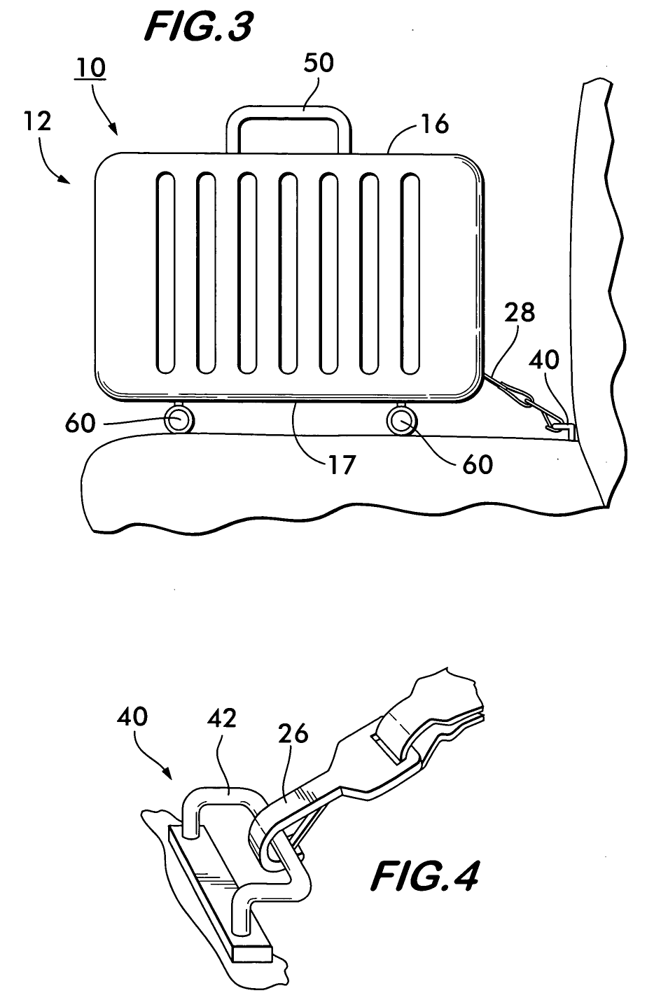

Belt 28 in an extended position is attached to LATCH system 40, as shown in FIGS. 3 and 4. LATCH system 40 includes mount 42 for receiving hook 26. LATCH system 40 is anchored into a vehicle. Upon insertion of hook 26 into mount 42, retaining slide 27 slides against mount 42 to couple hook 26 to mount 42.

Crate 13 can be formed of a rigid material such as plastic or metal. Handle 50 can be attached to top 16 of crate 50 for carrying secured animal carrier 10 when not secured to the vehicle. Wheels 60 can be attached to bottom 17 of crate 13 for providing portability of crate 13. Wheels 60 can be retractable into bottom 17 of crate 13.

It is to be understood that the above-described embodiments are illustrative of only a few of the many possible specific embodiments which can represent applications of the principles of the invention. Numerous and varied other arrangements can be readily devised in accordance with these principles by those skilled in the art without departing from the spirit and scope of the invention.

What is claimed is:

1. A secure animal carrier comprising:
an attachment coupled to said carrier, said attachment is compatible with a Low Anchors and Tethers for Children (LATCH) system, wherein said attachment couples said animal carrier to said LATCH system.

2. The secure animal carrier of claim 1 wherein said attachment is coupled to a rear of said animal carrier.

3. The secure animal carrier of claim 2 wherein said attachment extends into a side of said animal carrier.

4. The secure animal carrier of claim 2 wherein said attachment extends into said rear of said animal carrier.

5. The secure animal carrier of claim 2 wherein said attachment is retractable.

6. The secure animal carrier of claim 1 wherein said attachment is coupled to a side of said animal carrier.

7. The secure animal carrier of claim 1 wherein said attachment extends into the side of said animal carrier.

8. The secure animal carrier of claim 4 wherein said attachment is retractable.

9. The secure animal carrier of claim 1 wherein said attachment has a hook at one end adapted to be received in a mount of said LATCH system.

10. The secure animal carrier of claim 1 wherein said attachment has a belt coupled to said hook, said belt is coupled to an attachment mount positioned in a side of said carrier, said belt being retractable within said side of said carrier, wherein said belt is retracted for retracting said hook and is extended for extending said hook.

11. The secure animal carrier of claim 10 wherein said belt is flexible for retracting around said attachment mount.

12. The secure animal carrier of claim 1 wherein said attachment has a belt coupled to said hook, said belt is coupled to an attachment mount positioned in a rear of said carrier, said belt being retractable within said rear of said carrier, wherein said belt is retracted for retracting said hook and is extended for extending said hook.

13. The secure animal carrier of claim 12 wherein said belt is flexible for retracting around said attachment mount.

14. The secure animal carrier of claim 1 wherein said carrier is formed of a front frame, rear frame, a pair of side frames, top frame and bottom frame attached or integral to one another.

15. The secure animal carrier of claim 14 wherein said carrier further comprises a door in said front frame or said rear frame.

16. The secure animal carrier of claim 14 wherein said carrier further comprises a handle attached to said top frame of said carrier.

17. The secure animal carrier of claim 14 further comprises wheels attached to said bottom frame of said carrier.

18. The secure animal carrier of claim 17 wherein said wheels are retractable into said bottom frame.
